(19) United States
(12) Patent Application Publication
(10) Pub. No.: US 2017/0293336 A1
(43) Pub. Date: Oct. 12, 2017

(54) METHOD FOR READING IDENTIFICATION DATA FROM DISPLAY DEVICE AND ASSOCIATED PROCESSING CIRCUIT

(71) Applicant: MStar Semiconductor, Inc., Hsinchu Hsien (TW)

(72) Inventors: Shao-Hsien Wang, Hsinchu County (TW); Dien-Shen Chiang, Hsinchu County (TW); Chin-Lung Lin, Hsinchu County (TW)

(21) Appl. No.: 15/386,503

(22) Filed: Dec. 21, 2016

(30) Foreign Application Priority Data
Apr. 7, 2016 (TW) 105110885

(51) Int. Cl. G06F 1/26; G06F 1/28

(52) U.S. Cl. CPC G06F 1/266; G06F 1/28

(57) ABSTRACT

A method for reading identification data from a display device includes: receiving an external supply voltage via a display connector of the display device, and generating an internal supply voltage according to the external supply voltage; selectively providing one of the internal supply voltage and a system supply voltage to a microprocessor; and reading the identification data from a second memory by using the microprocessor, and storing the identification data to a first memory.

This application claims the benefit of Taiwan application Serial No. 105110885, filed Apr. 7, 2016, the subject matter of which is incorporated herein by reference.

### BACKGROUND OF THE INVENTION

### Field of the Invention

The invention relates in general to a display device, and more particularly to a method for reading identification data from a display device and an associated processing circuit.

### Description of the Related Art

Conventionally, when a video connector of a display device connects to a display card of an image transmitter (e.g., a computer host) via a connecting cable, the display card directly reads extended display identification data (EDID) in the display device, and transmits display data to the display device according to the EDID. In generally, the EDID is stored in an electrically-erasable programmable read-only memory (EEPROM), and includes associated information including screen resolution, name of manufacturer and serial number. However, using the EEPROM to store the EDID increases production costs and hence lowers product competitiveness.

### SUMMARY OF THE INVENTION

Therefore, it is an object of the present invention to provide a method for reading identification data from a display device and an associated processing circuit, which eliminate the issue of storing extended display identification data (EDID) by an EEPROM and prevent side-effects that are additionally caused by using other storage components, thereby solving the issues of the prior art.

A processing circuit applied to a display device is disclosed according to an embodiment of the present invention. The processing circuit includes a first memory, a microprocessor, an internal voltage source and a selecting circuit. The microprocessor reads identification data from a second memory, and stores the identification data to the first memory. The internal voltage source receives an external supply voltage from a video connector of the display device, and generates an internal voltage supply according to the external voltage supply. The selecting circuit selects and provides one of the internal supply voltage and a system supply voltage to the first memory, the second memory and the microprocessor.

According to another embodiment of the present invention, a method for reading identification data from a display device includes: receiving an external supply voltage from a video connector of the display device, and generating an internal voltage supply according to the external supply voltage; selectively providing one of the internal supply voltage and a system supply voltage to a microprocessor; and reading identification data from the second memory by using the microprocessor, and storing the identification data to the first memory.

According to another embodiment of the present invention, a processing circuit applied to a display device that includes a first memory and a second memory is provided. The processing circuit includes a microprocessor, an internal voltage source and a selecting circuit. The microprocessor reads identification data from the second memory, and stores the identification data to the first memory. The internal voltage source receives an external supply voltage from a video connector of the display device, and generates an internal supply voltage according to the external supply voltage. The selecting circuit selectively provides one of the internal supply voltage and a system supply voltage to the first memory, the second memory and the microprocessor.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a display device according to an embodiment of the present invention;

FIG. 2 is a block diagram of a processing circuit according to an embodiment of the present invention;

FIG. 3 is a block diagram of a selecting circuit according to an embodiment of the present invention; and

FIG. 4 is a flowchart of a method for reading identification data from a display device according to an embodiment of the present invention.

### DETAILED DESCRIPTION OF THE INVENTION

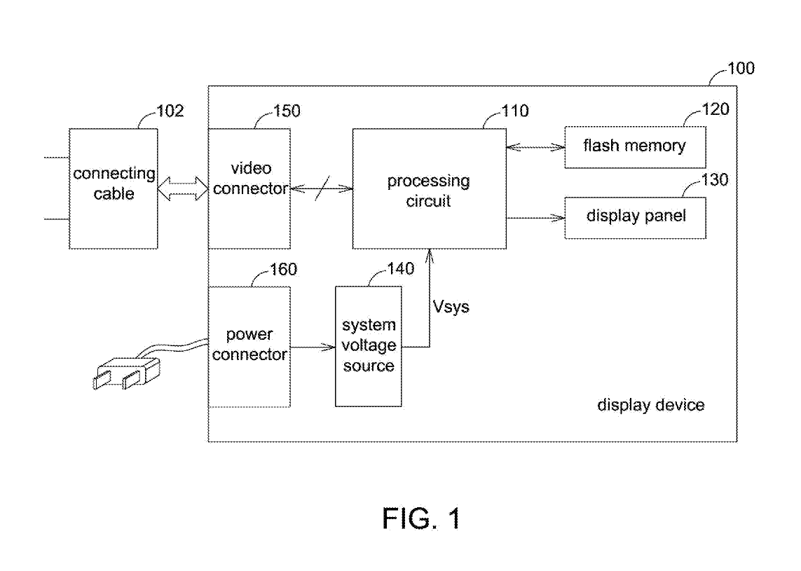

FIG. 1 shows a block diagram of a display device 100 according to an embodiment of the present invention. As shown in FIG. 1, a display device 100 at least includes a processing circuit 110, a flash memory 120, a display panel 130, a system voltage source 140, a video connector 150 and a power connector 160. The video connector 150 is connected to a display card of an external computer host via a connecting cable 102. In the embodiment, the processing circuit 110 mainly performs operations of scaling and other signal processes on multimedia data received from the external computer host via the video connector 150 to generate image data, which is then forwarded to the display panel for display. The flash memory 120, located outside the processing circuit 110, stores extended display identification data (EDID) of the display device 100. The system voltage source 140 converts a voltage received from city electricity via the power connector 160 to a system supply voltage Vsys suitable for operations of internal circuits. The video connector 150 may be a Digital Visual Interface (DVI), a High Definition Multimedia Interface (HDMI), a composite video connector or connectors of other video standards, and is used to receive corresponding audiovisual data and provide a 5V voltage. The connecting cable 102 is a transmission line compliant to the standard of the video connector 150, e.g., a DVI or HDMI transmission line.

In this embodiment, the processing circuit 110 may also receive an external voltage source from the external computer host via the video connector 150, and convert the external voltage source to an internal supply voltage, which then powers the processing circuit 110 and the flash memory 120. As such, the processing circuit 110 may read the EDID stored in the flash memory 120, and transmit the read EDID to the display card in the external computer host via the video connector 150 and the connecting cable 102. Thus, with the function of the processing circuit 110 of the present invention, when the power connector 160 of the display device 100 is not connected to an external power, the EDID may be similarly read for the use of the display card of the external computer host. Further, as no EEPROM needs to be used to store the EDID, production costs may be reduced without compromising the functionality. It should be noted that, because a display device generally includes the flash memory 120, the approach of storing the EDID in the flash memory does not increase any additional production costs.

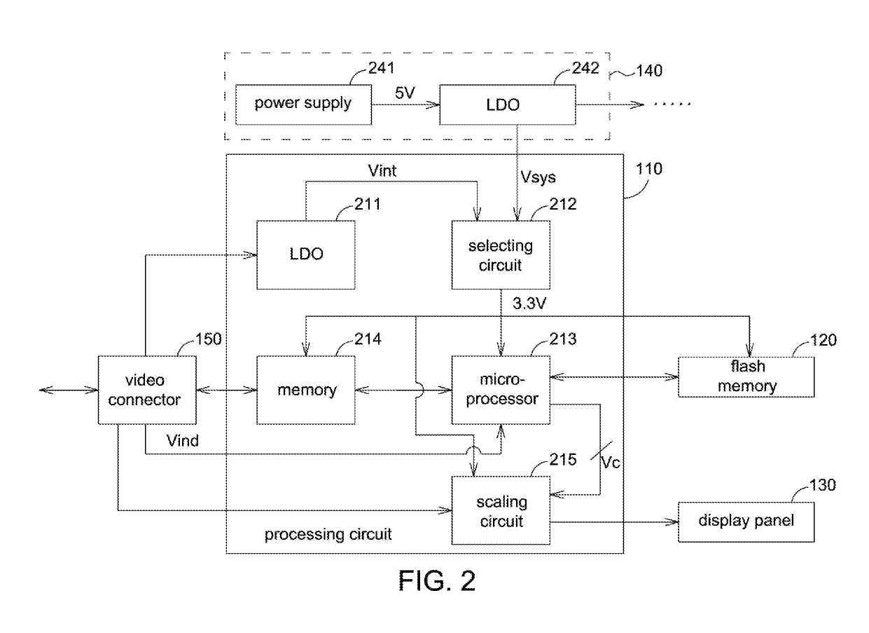

More specifically, FIG. 2 shows a block diagram of the processing circuit 110 according to an embodiment of the present invention. As shown in FIG. 2, the processing circuit 110 includes a low-dropout linear regulator (LDO) 211, a selecting circuit 212, a microprocessor 213, a memory 214 and a scaling circuit 215. Further, the system voltage source 140 includes a power supply 214 and an LDO 242. In this embodiment, the selecting circuit 212 may be a multiplexer, and the memory 214 may be a static random access memory (SRAM).

Concerning the components in FIG. 2, the power supply 241 generates a 5V voltage, and the LDO 242 generates the system power supply Vsys according to the 5V voltage to the processing circuit 110. In this embodiment, the system supply voltage Vsys is 3.3V. On the other hand, the LDO 211 in the processing circuit 110 receives a 5V voltage from the video connector 150, and generates an internal supply voltage Vint according to the 5V voltage. In this embodiment, the internal supply voltage Vint is also 3.3V. Further, other components in the processing circuit 110 and the flash memory 120 are powered by the system supply voltage Vsys or the internal supply voltage Vint. Internal operations of the processing circuit 110 are given for two scenarios of whether the system supply voltage Vsys is present or absent.

When the power connector 160 of the display device 100 is not connected to a power, the system voltage source 140 does not generate the system supply voltage Vsys to the processing circuit 110. At this point, if the display device 100 is connected to the external computer host via the connecting cable 102, the LDO 211 in the processing circuit 110 generates the internal supply voltage Vint according to the 5V voltage that the video connector 150 receives, and the selecting circuit 212 provides the internal supply voltage Vint to the microprocessor 213, the memory 214 and the flash memory 120. Once powered, the microprocessor 213 transmits a read instruction to the flash memory 120 to request to read data in the flash memory 120, performs a decoding operation (e.g., an error correction decoding process) on the read data to obtain the EDID, and temporarily stores the EDID in the memory 214 for the external computer host to read via the connecting cable 102 and the video connector 150. In one embodiment, an address at which the EDID is temporarily stored in the memory 214 is predetermined, and so the EDID may be directly read from the predetermined address in the memory 214 without additional communication with the microprocessor 213 when the external computer host reads the EDID via the connecting cable 102 and the video connector 150. Further, the external computer host may read the EDID from the memory 214 only when an indication signal indicating that the EDID data is already stored in the memory 214, or may persistently read the memory 214 until the EDID is obtained.

On the other hand, when the power connector 160 of the display device 100 is connected to a power, the system voltage source 140 generates the system supply voltage Vsys to the processing circuit 110 to power the entire processing circuit 110 and the flash memory 120. At this point, if the display device 100 is connected to the external computer host via the connecting cable 102, the processing circuit 110 and the flash memory 120 are both in a powered state. Thus, the microprocessor 213 directly transmits a read instruction to the flash memory 120 to request to read the data in the flash memory 120, performs a decoding operation (e.g., an error correction decoding operation) on the read data to obtain the required EDID, and temporarily stores the EDID in the memory 214 for the external computer host to read via the connecting cable 102 and the video connector 150. It should be noted that, the selecting circuit 212 at this point turns off the paths from the internal supply voltage Vint to other components in the processing circuit 110, i.e., the internal supply voltage Vint is not transmitted to the microprocessor 213, the memory 214 and the flash memory 120.

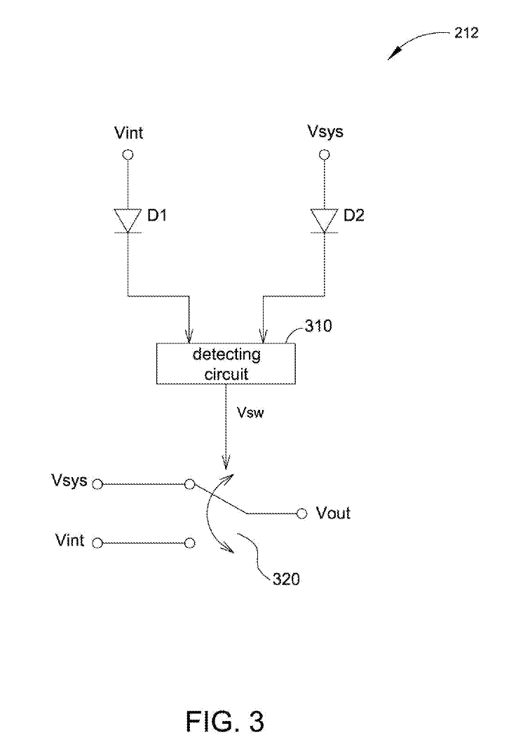

Further, in the structure in FIG. 2, when the processing circuit 110 is powered by the internal supply voltage Vint, to prevent the current generated by the internal supply voltage Vint from flowing in reverse to other components in the display device 100 through the selecting circuit 212 and the LDO 242 and resulting in power waste, the selecting circuit 212 may be implemented by a multiplexer or a similar switch circuit, thereby eliminating such reversed current. FIG. 3 shows a block diagram of the selecting circuit 212 according to an embodiment of the present invention. As shown in FIG. 3, the selecting circuit 212 includes two diodes D1 and D2, a detecting circuit 310 and a switch element 320. In the operation of the selecting circuit 212 in FIG. 3, the supply voltage to the detection circuit 310 is provided by the system supply voltage Vsys or the internal supply voltage Vint. In other words, given that one of the system supply voltage Vsys and the internal supply voltage Vint is present, the detecting circuit 310 is operable. Further, the detecting circuit 310 may detect whether the system supply voltage Vsys is present, e.g., detecting a voltage value of a pin of the chip to determine whether the system supply voltage Vsys is present, and accordingly generate a switch control signal Vsw to selectively use the system supply voltage Vsys or the internal supply voltage Vint as an output voltage Vout to the microprocessor 213, the memory 214 and the flash memory 120. More specifically, when the detecting circuit 310 detects that the system supply voltage Vsys is absent, it generates the switch control signal Vsw to the switch element 320 to use the internal supply voltage Vint as the output voltage. Otherwise, when the detecting circuit 310 detects that the system supply voltage Vsys is present, it generates the switch control signal Vsw to the switch element 320 to use the system supply voltage Vsys as the output voltage Vout. With the above approach and the structure in FIG. 3, the issue of the reversed current can be eliminated.

It should be noted that, the circuit structures shown in FIG. 2 and FIG. 3 are merely examples for illustration purposes, and are not to be construed as limitations to the present invention. In other embodiments of the present invention, when the system supply voltage Vsys is present, the system supply voltage Vsys may be directly provided to the microprocessor 213, the memory 213 and the flash memory 120 without going through the selecting circuit 212. In other words, the selecting circuit 212 serves the sole purpose of selectively providing the internal supply voltage Vint, and the system supply voltage Vsys is transmitted via other paths to the microprocessor 213, the memory 214 and the flash memory 120.

Further, the scaling circuit 215 may be powered by the internal supply voltage Vint or the system supply voltage Vsys, with the current provided by the internal supply voltage Vint usually being lower (e.g., 500 mA), and the current provided by the system supply voltage Vsys usually being higher (e.g., 3 A to 4 A). Thus, in one embodiment, when the system supply voltage Vsys is absent, in order to prevent data processing errors caused by insufficient current that the internal supply voltage Vint provides, the microprocessor 213 generates a control signal Vc to disable a part of the functions or all of the functions in the scaling circuit 215 to save power. On the other hand, the microprocessor 213 may also determine whether to disable at least a part of the functions in the scaling circuit 215 according to an indication signal Vind from the video connector 150. The indication signal Vind indicates whether the external computer host transmits data to the display device 100 for display, and may be a clock signal or a synchronization signal based on different specifications. In another embodiment, when the microprocessor 213 does not receive the indication signal Vind, the microprocessor 213 directly generates the control signal Vc to disable at least a part of the functions or all of the functions in the scaling circuit 215 to save power.

The operations of the components in the processing circuit 110 may be summarized as below. 1) When the system supply voltage Vsys is present, the display device 110 is connected to the external computer host and the microprocessor 213 receives the indication signal Vind, the entire processing circuit 110 is functional and operable, and the microprocessor 213, the memory 214, the scaling circuit 215 and the flash memory 120 are all powered by the system supply voltage Vsys. 2) When the system supply voltage Vsys is present and the display device 110 is connected to the external computer host, but the microprocessor 213 does not receive the indication signal Vind, the microprocessor 213 disables at least a part of the functions in the scaling circuit 215, and the microprocessor 213, the memory 214 and the flash memory 120 are powered by the system supply voltage Vsys for operations. 3) When the system supply voltage Vsys is present, but the display device 110 is not connected to the external computer host and the microprocessor 213 does not receive the indication signal Vind, the microprocessor 213 disables at least a part of the functions in the scaling circuit 215, and the microprocessor 213, the memory 214 and the flash memory 120 are powered by the system supply voltage Vsys for operations. 4) When the system supply voltage Vsys is absent, the display device 100 is connected to the external computer host, and whether or not the microprocessor 213 receives the indication signal Vind, the microprocessor 213 disables at least a part of the functions in the scaling circuit 215, and the microprocessor 213, the memory 214 and the flash memory 120 are powered by the internal supply voltage Vint for operations.

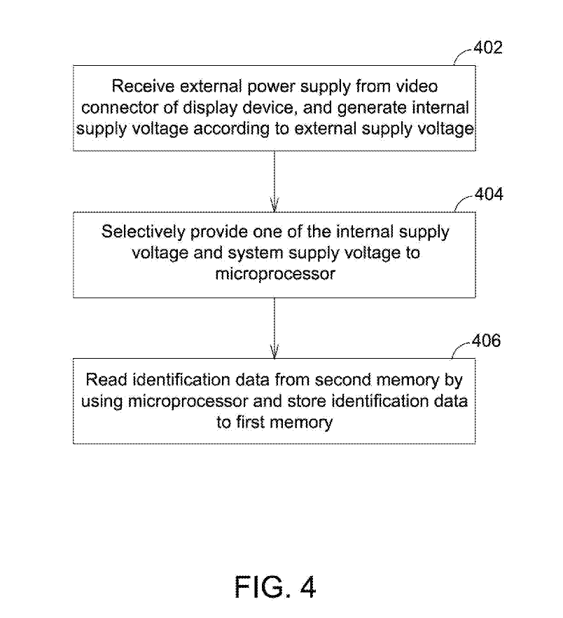

FIG. 4 shows a flowchart of a method for reading identification data from a display device according to an embodiment of the present invention. Referring to FIG. 1 to FIG. 4 as well as the above disclosure, the method includes following steps.

In step 402, an external supply voltage is received from a video connector of a display device, and an internal supply voltage is generated according to the external supply voltage.

In step 404, one of the internal supply voltage and the system supply voltage is selectively provided to a microprocessor.

In step 406, the identification data is read from a second memory by using the microprocessor, and the identification data is stored to a first memory.

In conclusion, the method for reading identification data from a display device and the associated processing circuit of the present invention eliminate the issue that the display device uses an EEPROM to store EDID to reduce costs. Further, in an event where the display device is not connected to a power connector, an external computer host connected to the display device is allowed to first obtain the identification data of the display device, so as to prevent the issue of a reversed current caused when the display device uses an internal supply voltage of the external computer host. Therefore, the present invention lowers production costs and saves power at the same time.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A processing circuit, applied to a display device, comprising:
a first memory;
a microprocessor, reading identification data from a second memory, and storing the identification data to the first memory;
an internal voltage source, receiving an external supply voltage from a video connector of the display device, and generating an internal supply voltage according to the external supply voltage; and
a selecting circuit, selectively providing one of the internal supply voltage and a system supply voltage to the first memory, the second memory and the microprocessor.

2. The processing circuit according to claim 1, wherein the second memory is a flash memory and the identification data is extended display identification data (EDID) of the display device.

3. The processing circuit according to claim 1, being a chip, wherein the second storage is outside the chip.

4. The processing circuit according to claim 1, further comprising:
a scaling circuit, processing multimedia data received from the video connector to generate processed data, and transmitting the processed data to a display panel of the display device;
wherein, the microprocessor selectively enables or disables a part of functions in the scaling circuit according to an indication signal received from the video connector.

5. The processing circuit according to claim 1, wherein the indication signal is one of a clock signal and a synchronization signal.

6. The processing circuit according to claim 4, wherein when the system supply voltage is present and the microprocessors receives the indication signal, the selecting circuit provides the system supply voltage to the microprocessor, the first memory, the second memory and the scaling circuit.

7. The processing circuit according to claim 4, wherein when the system supply voltage is present and the microprocessor does not receive the indication signal, the selecting circuit provides the system supply voltage to the microprocessor, the first memory the second memory and the scaling circuit, and the microprocessor disables the part of the functions in the scaling circuit.

8. The processing circuit according to claim 4, wherein when the system supply voltage is absent, the selecting circuit provides the internal supply voltage to the microprocessor, the first memory, the second memory and the scaling circuit, and the microprocessor disables the part of the functions in the scaling circuit.

9. The processing circuit according to claim 1, wherein the selecting circuit comprises:
a detecting circuit, detecting whether the system supply voltage is present.

10. A method for reading identification data from a display device, comprising:
receiving an external supply voltage from a video connector of the display device, and generating an internal supply voltage according to the external supply voltage;
selectively providing one of the internal supply voltage and a system supply voltage to a microprocessor; and
reading the identification data from a second memory by using the microprocessor, and storing the identification data to the first memory.

11. The method according to claim 10, wherein the second memory is a flash memory, and the identification data is extended display identification data (EDID) of the display device.

12. The method according to claim 10, further comprising:
processing multimedia data received from the video connector to generate processed data, and transmitting the processed data to a display panel of the display device; and
selectively enabling or disabling a part of functions in the scaling circuit according to an indication signal received from the video connector.

13. The method according to claim 12, wherein the indication signal is one of a clock signal and a synchronization signal.

14. The method according to claim 12, wherein the step of processing the multimedia data to generate the processed data is performed by a scaling circuit; when the system supply voltage is present and the microprocessors receives the indication signal, the system supply voltage is provided to the microprocessor, the first memory, the second memory and the scaling circuit.

15. The method according to claim 12, wherein the step of processing the multimedia data to generate the processed data is performed by a scaling circuit; when the system supply voltage is present and the microprocessors does not receive the indication signal, the system supply voltage is provided to the microprocessor, the first memory, the second memory and the scaling circuit, and the microprocessor disables the part of the functions in the scaling circuit.

16. The method according to claim 12, wherein the step of processing the multimedia data to generate the processed data is performed by a scaling circuit; when the system supply voltage is absent, the internal supply voltage is provided to the microprocessor, the first memory, the second memory and the scaling circuit, and the microprocessor disables the part of the functions in the scaling circuit.

17. The method according to claim 12, wherein the step of selectively providing one of the internal supply voltage and the system supply voltage to the microprocessor comprises:
detecting whether the system supply voltage is present, and accordingly providing one of the internal supply voltage and the system supply voltage to the microprocessor.

18. A processing circuit, applied to a display device which comprises a first memory and a second memory, comprising:
a microprocessor, reading identification data from the second memory, and storing the identification data to the first memory;
an internal voltage source, receiving an external supply voltage from a video connector of the display device, and generating an internal supply voltage according to the external supply voltage; and
a selecting circuit, selectively providing one of the internal supply voltage and a system supply voltage to the first memory, the second memory and the microprocessor.
